(19) United States
(12) Patent Application Publication
(10) Pub. No.: US 2017/0190851 A1
(43) Pub. Date: Jul. 6, 2017

(54) COMPOSITE CORE STRUCTURE AND METHOD

(71) Applicant: Sikorsky Aircraft Corporation, Stratford, CT (US)

(72) Inventor: Jonathan K. Garhart, Seymour, CT (US)

(21) Appl. No.: 15/391,342

(22) Filed: Dec. 27, 2016

Related U.S. Application Data
(60) Provisional application No. 62/272,961, filed on Dec. 30, 2015.

(51) Int. Cl. C08J 5/04; B29C 51/10

(52) U.S. Cl. CPC C08J 5/042; B29C 51/10; B29L 2031/731

(57) ABSTRACT

A composite core structure includes a core having a plurality of elongated fibers and a plurality of spherical members, the elongated fibers and spherical members consolidated into a desired molded shape. The composite core structure also includes a matrix material encapsulating the elongated fibers and spherical members.

### CROSS REFERENCE TO RELATED APPLICATIONS

This application claims the benefit of Provisional Application No. 62/272,961, filed Dec. 30, 2015, the contents of which is incorporated by reference in its entirety herein.

### BACKGROUND

The embodiments herein relate to composite structures and, more particularly, to core materials for such structures, as well as a method of forming composite core structures.

Composite core materials are typically either honeycomb or closed cell foam. The honeycomb option is supplied in uniform thickness sheets and is difficult to shape to contour or cut into complex forms. Closed cell foam materials are more easily shaped, relative to honeycomb structures, but have limited structural properties. Therefore, distinct disadvantages are associated with each of the two primary composite core materials, with a tradeoff between shape flexibility and structural property flexibility imposing constraints on composite structure manufacturers.

### BRIEF DESCRIPTION

According to one embodiment, a composite core structure includes a core having a plurality of elongated fibers and a plurality of spherical members, the elongated fibers and spherical members consolidated into a desired molded shape. The composite core structure also includes a matrix material which integrates the elongated fibers and spherical members into a monolithic structure.

In addition to one or more of the features described above, or as an alternative, further embodiments may include that the spherical members are hollow.

In addition to one or more of the features described above, or as an alternative, further embodiments may include that the plurality of elongated fibers includes a plurality of lengths.

In addition to one or more of the features described above, or as an alternative, further embodiments may include that the spherical members are formed of thermoplastic.

In addition to one or more of the features described above, or as an alternative, further embodiments may include that the elongated fibers are formed of carbon fiber.

According to another embodiment, a slurry for forming a composite core structure includes a suspension medium. The slurry also includes a plurality of elongated fibers disposed in the suspension medium. The slurry further includes a plurality of spherical members disposed in the suspension medium.

In addition to one or more of the features described above, or as an alternative, further embodiments may include that the suspension medium is a fluid.

In addition to one or more of the features described above, or as an alternative, further embodiments may include that the spherical members are hollow.

In addition to one or more of the features described above, or as an alternative, further embodiments may include that the plurality of elongated fibers includes a plurality of lengths.

In addition to one or more of the features described above, or as an alternative, further embodiments may include that the spherical members are formed of thermoplastic.

In addition to one or more of the features described above, or as an alternative, further embodiments may include that the elongated fibers are formed of carbon fiber.

According to yet another embodiment, a method of forming a composite core structure is provided. The method includes providing a slurry comprising a suspension medium, a plurality of elongated fibers disposed in the suspension medium, and a plurality of hollow spherical members disposed in the suspension fluid. The method also includes drawing the slurry into a mold form with a porous base. The method further includes filtering the suspension medium out of the mold form through the porous base. The method yet further includes consolidating the elongated fibers and the hollow spherical members into the desired form. The method also includes infusing a matrix material into the mold form for mixing with the elongated fibers and the hollow spherical members. The method further includes hardening the matrix material, elongated fibers and hollow spherical members into a monolithic structure.

In addition to one or more of the features described above, or as an alternative, further embodiments may include that the elongated fibers and the hollow spherical members are consolidated in the mold form under vacuum.

In addition to one or more of the features described above, or as an alternative, further embodiments may include that any residue of the suspension medium is removed through a flushing step after consolidation.

In addition to one or more of the features described above, or as an alternative, further embodiments may include customizing the structural properties of the composite core structure based on modification of at least one structural factor.

In addition to one or more of the features described above, or as an alternative, further embodiments may include that the at least one structural factor comprises at least one of density of the elongated fibers, size of the hollow spherical members and constituent materials.

### BRIEF DESCRIPTION OF THE DRAWINGS

The subject matter which is regarded as the present disclosure is particularly pointed out and distinctly claimed in the claims at the conclusion of the specification. The foregoing and other features and advantages of the present disclosure are apparent from the following detailed description taken in conjunction with the accompanying drawings in which:

FIG. 1 illustrates a slurry for a composite core structure, the core structure being at a first stage of manufacture;

FIG. 2 illustrates the slurry with a suspension medium removed, the core structure being at a second stage of manufacture;

FIG. 3 illustrates the formed composite core structure at a third stage of manufacture; and

FIG. 4 is a flow diagram illustrating a method of forming the composite core structure.

### DETAILED DESCRIPTION

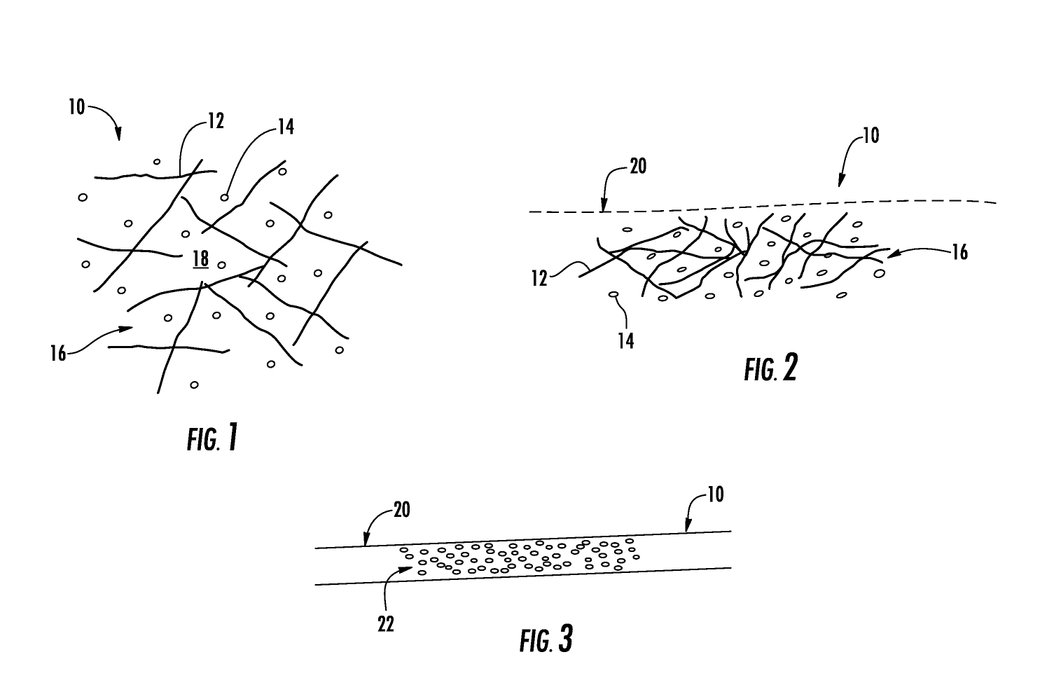

Referring to FIGS. 1-3, a composite structure is illustrated at various stages of manufacture. More specifically, a composite core structure 10 is shown. The composite core structure 10 described herein may be employed in any application that benefits from the use of composite structures. In some embodiments, the composite core structure 10 is employed in the aerospace industry, such as in association with a rotary wing aircraft, for example.

As will be appreciated from the description herein, the composite core structure 10 is manufactured in a manner that provides a manufacturer with flexibility related to both shaping and structural properties. In other words, the composite core structure 10 may be contoured or cut into complex geometries, while still being formed in a customizable manner with regard to structural properties, such as strength or elastic modulus, for example.

The composite core structure 10 includes a plurality of elongated fibers 12 and a plurality of spherical members 14 that are randomly mixed with each other during manufacture of the composite core structure 10. The elongated fibers 12 may be formed of various materials, including carbon fiber in some embodiments. The elongated fibers 12 are of different lengths in some embodiments. In such embodiments, some or all of the fibers have lengths that differ from the other fibers. The spherical members 14 are hollow in some embodiments. In some embodiments, the spherical members 14 are formed of a low density material. The spherical members 14 may be formed of various contemplated materials. In one embodiment, the spherical members 14 are formed of thermoplastic. While the geometric configuration of a sphere is illustrated and primarily described herein, it is to be understood that deviations from a sphere are contemplated. For example, an oval structure may be employed or any suitable alternative.

FIG. 1 illustrates the composite core structure 10 in a first stage of manufacture. In particular, a slurry 16 is illustrated. The slurry 16 includes the elongated fibers 12 and the spherical members 14 suspended in a suspension medium 18 to establish a random mix of the elongated fibers 12 and the spherical members 14. In some embodiments, the suspension medium 18 is a fluid in the form of a liquid or gas. Two-phase substances (i.e., liquid-gas or liquid-solid) are also contemplated.

FIG. 2 illustrates the composite core structure 10 in a second stage of manufacture. The above-described slurry 16 is drawn into a mold form 20 that is shaped to a desired geometry. The mold form 20 includes a porous base that facilitates removal of the suspension medium 18 from the slurry 16 while disposed in the mold form 20. The porous base allows filtering out of the suspension medium 18 to leave a homogenous interlocking mix of the elongated fibers 12 and the spherical members 14 in the mold form 20. The suspension medium 18 is completely removed and the remaining mass of elongated fibers and spherical members 14 is consolidated. Removal of the suspension medium 18 and consolidation of the elongated fibers 12 and the spherical members 14 is done under vacuum in some embodiments.

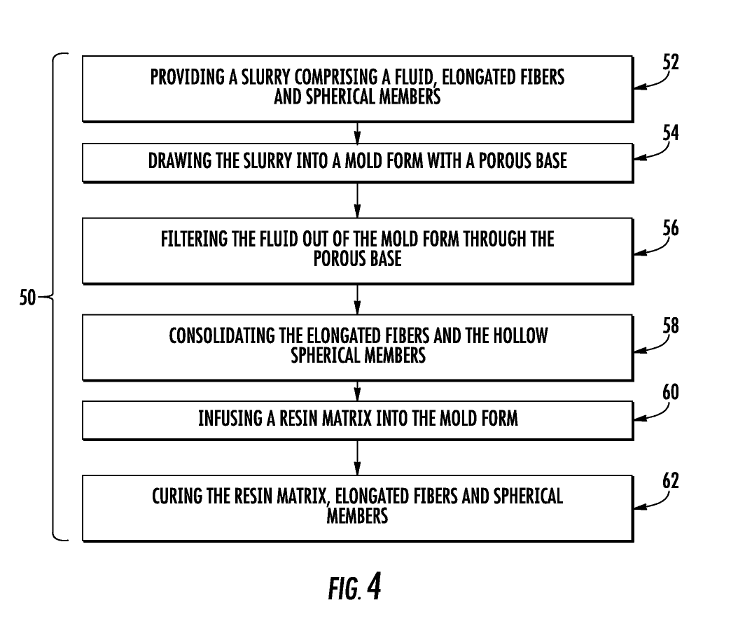

FIG. 3 illustrates the composite core structure 10 in a third stage of manufacture. Once the elongate fibers 12 and the spherical members 14 are consolidated into the desired shape in the mold form 20, a matrix material 22 is infused into the void space to coat and encapsulate the elongated fibers 12 and the spherical members 14. Once the matrix material 22 is settled in the mold form 20, the elongated fibers 12, the spherical members 14 and the matrix material 22 are hardened to form the final composite core structure 10. Exemplary materials that the matrix material 22 comprises are resin, concrete, thermoplastic and metal. The preceding list is merely illustrative and not limiting. Some materials are hardened by curing, while others do not require curing.

Referring now to FIG. 4, a flow diagram schematically illustrates a summary of a method 50 of forming the composite core structure 10 according to an embodiment. The method 50 includes providing 52 the slurry 16 that includes the suspension medium 18, the elongated fibers 12 and the spherical members 14. The slurry 16 is drawn 54 into the mold form 20. The suspension medium 18 is filtered 56 out of the mold form 20 through the porous base and the remaining elongated fibers 12 and spherical members 14 are consolidated 58. The matrix material 22 is infused 60 into the mold form 20 for mixing with the elongated fibers 12 and the spherical members 14. The matrix material 22, the elongated fibers 12 and the spherical members 14 are hardened 62 to form the final composite core structure 10.

Advantageously, the composite core structure 10 has isotropic properties and is able to be molded into any desired shape during manufacturing with strength based on the capability of the embedded fiber rather than traditional materials. A composite core structure 10 manufactured in this manner possesses a wide range of customizable properties, including moduli, based on at least one structural factor that may be manipulated by a manufacturer to obtain desired properties. The at least one structural factor may include strength or density of the elongated fibers, size of the spherical members and/or constituent materials used.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A composite core structure comprising:
a core having a plurality of elongated fibers and a plurality of spherical members, the elongated fibers and spherical members consolidated into a desired molded shape; and
a matrix material encapsulating the elongated fibers and spherical members.

2. The composite structure of claim 1, wherein the spherical members are hollow.

3. The composite structure of claim 1, wherein the plurality of elongated fibers includes a plurality of lengths.

4. The composite structure of claim 1, wherein the spherical members are formed of thermoplastic.

5. The composite structure of claim 1, wherein the elongated fibers are formed of carbon fiber.

6. A slurry for forming a composite core structure comprising:
a suspension medium;
a plurality of elongated fibers disposed in the suspension medium; and
a plurality of spherical members disposed in the suspension medium.

7. The slurry of claim 6, wherein the suspension medium is a fluid.

8. The slurry of claim 6, wherein the spherical members are hollow.

9. The composite structure of claim 6, wherein the plurality of elongated fibers includes a plurality of lengths.

10. The composite structure of claim 6, wherein the spherical members are formed of thermoplastic.

11. The composite structure of claim 6, wherein the elongated fibers are formed of carbon fiber.

12. A method of forming a composite core structure comprising:
providing a slurry comprising a suspension medium, a plurality of elongated fibers disposed in the suspension medium, and a plurality of hollow spherical members disposed in the suspension medium;
drawing the slurry into a mold form with a porous base;
filtering the suspension medium out of the mold form through the porous base;
consolidating the elongated fibers and the hollow spherical members;
infusing a matrix material into the mold form for mixing with the elongated fibers and the hollow spherical members; and
hardeneing the matrix material, elongated fibers and hollow spherical members into a structure.

13. The method of claim 12, wherein the structure is a monolithic structure.

14. The method of claim 12, wherein the elongated fibers and the hollow spherical members are consolidated in the mold form under vacuum.

15. The method of claim 12, further comprising customizing the structural properties of the composite core structure based on modification of at least one structural factor.

16. The method of claim 15, wherein the at least one structural factor comprises at least one of density or strength of the elongated fibers, size of the hollow spherical members and constituent materials.

17. The method of any of claim 12, further comprising removing any residue of the suspension medium through a flushing process after consolidation.
